(19) United States
(12) Patent Application Publication
(10) Pub. No.: US 2019/0253741 A1
(43) Pub. Date: Aug. 15, 2019

(54) Distributed Image Analysis System

(71) Applicant: GORILLA TECHNOLOGY INC., Taipei City (TW)

(72) Inventors: SIH-PING KOH, Taipei City (TW); NUO PAI HSU, Taipei City (TW)

(21) Appl. No.: 16/258,676

(22) Filed: Jan. 28, 2019

(30) Foreign Application Priority Data
Feb. 13, 2018 (TW) 107105248

(51) Int. Cl. H04N 21/234; G06T 7/70; G06T 7/20

(52) U.S. Cl. CPC H04N 21/23418; G06T 2207/10016; G06T 7/20; G06T 7/70

(57) ABSTRACT

A distributed image analysis system comprising a plurality of video analysis devices and a cluster management device, wherein when a video analysis device performs a video analysis of a video stream but cannot complete it by itself, at least one portion of the task of the video analysis of the video stream is distributed to other video analysis devices through the cluster management device so as to complete the video analysis of the video stream.

### CROSS-REFERENCE TO RELATED APPLICATION

This application claims the Priority of Taiwan application No. 107105248 filed Feb. 13, 2018, the disclosure of which is incorporated herein in its entirety by reference.

### BACKGROUND OF THE INVENTION

### 1. Field of the Invention

The present invention relates to an image analysis system, and more particularly, to a distributed image analysis system.

### 2. Description of the Prior Art

Conventional image analysis devices are generally designed for specific image analysis functions and are limited by hardware constraints when performing image analyses that require a great deal of computing power. As a result, conventional image analysis devices cannot analyze a complex video stream that requires a great deal of computing power. In addition, the cost of an image analysis device is still too high, and conventional video recording devices still focus on video recording and playback. Even though some conventional video recording devices have image analysis capabilities, it is still difficult to use them for analyzing a complex video stream due to lack of system support.

Accordingly, there is a need to provide a distributed image analysis system capable of analyzing complex video streams that require a great deal of computational efficiency in the industry.

### SUMMARY OF THE INVENTION

One object of the present invention is to provide a distributed image analysis system capable of enabling a plurality of image analysis devices to support each other to fully utilize the resources of the plurality of image analysis devices so as to complete the analyses of a complex video stream, thereby reducing the cost of the system. The analyses of the complex video stream in the context of the present invention refers to the analyses of a video stream that cannot be completed by a single image analysis device.

In one embodiment, a distributed image analysis system is disclosed, wherein the distributed image analysis system comprises: a plurality of image analysis devices for analyzing video streams; and a cluster management device connected to the plurality of image analysis devices; wherein when a first image analysis device of the plurality of image analysis devices performs the analyses of a video stream but is not capable of completing the analyses of the video stream by itself, at least one portion of the tasks of the analyses of the video stream is transferred to the cluster management device and/or at least one second image analysis device of the plurality of image analysis devices so as to complete the analyses of the video stream.

In one embodiment, wherein the cluster management device transfers the at least one portion of the tasks of the analyses of the video stream to the at least one second image analysis device, and the cluster management device transmits an execution result of the at least one portion of the tasks of the analyses of the video stream back to the first image analysis device so as to complete the video stream analyses.

In one embodiment, wherein the cluster management device is connected to a cloud analysis service device, wherein when the at least one portion of the tasks of the analyses of the video stream includes an image analysis task and the plurality of image analysis devices do not have the capability of performing said image analysis task, the cluster management device transfers the image analysis task to the cloud analysis service device for execution, and an execution result of the image analysis task is transmitted back to the first image analysis device from the cloud analysis service device so as to complete the video stream analyses.

In one embodiment, wherein the cloud analysis service device transmits the execution result of the image analysis task back to the first image analysis device through the cluster management device.

In one embodiment, the cloud analysis service device transmits the execution result of the image analysis task back to the first image analysis device directly.

In one embodiment, when the first image analysis device detects an event in an analysis of an image, the first image analysis device transfers the image to the cloud analysis service device for determining a probability score that the image contains an abnormal condition, and the cloud analysis service device transmits the probability score back to the first image analysis device.

In one embodiment, the first image analysis device detects the event by performing a preliminary analysis of the image, and the event is detected when a result of the preliminary analysis meets a triggering condition.

In one embodiment, the first image analysis device receives a message from a detection device so as to detect the event.

In one embodiment, the abnormal condition is detected when the image contains a dangerous article or a fire scene.

In one embodiment, the triggering condition is a motion of an object.

In one embodiment, the detection device is a temperature detection device.

In one embodiment, a distributed image analysis system is disclosed, wherein the distributed image analysis system comprises: a plurality of image analysis devices for analyzing video streams; and a cluster management device connected to the plurality of image analysis devices; wherein when a first image analysis device of the plurality of image analysis devices performs the analyses of a video stream but is not capable of completing the analyses of the video stream by itself, at least one portion of the tasks of the analyses of the video stream is transferred to the cloud analysis service device and/or at least one second image analysis device of the plurality of image analysis devices via the cluster management device so as to complete the analyses of the video stream.

In one embodiment, a distributed image analysis system is disclosed, wherein the distributed image analysis system comprises: an image analysis device, wherein the image analysis device is connected to a cloud analysis service device; and wherein when the image analysis device of the plurality of image analysis devices performs the analyses of a video stream but is not capable of completing the analyses of the video stream by itself, at least one portion of the tasks of the analyses of the video stream is transferred to the cloud analysis service device and the cloud analysis service device transmits a result of the at least one portion of the tasks of the analyses of the video stream back to the image analysis device so as to complete the analyses of the video stream.

In one embodiment, when the image analysis device detects an event in an image, the image analysis device transfers the image to the cloud analysis service device to determine a probability score that the image contains an abnormal condition, and the cloud analysis service device transmits the probability score back to the image analysis device.

In one embodiment, the image analysis device detects the event by a preliminary analysis of the image, and the event is detected when the preliminary analysis meets a triggering condition.

In one embodiment, the image analysis device receives a message from a detection device so as to detect the event.

In one embodiment, the abnormal condition is detected when the image contains a dangerous article or a fire scene.

In one embodiment, the triggering condition is a motion of an object.

In one embodiment, the detection device is a temperature detection device.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram illustrating an image analysis system in one embodiment of the present invention;

FIG. 2 is a schematic diagram illustrating an image analysis system in one embodiment of the present invention;

FIG. 3 is a schematic diagram illustrating an image analysis system in one embodiment of the present invention; and

FIG. 4 is a schematic diagram illustrating an image analysis system in one embodiment of the present invention.

### DESCRIPTION OF THE PREFERRED EMBODIMENT

The foregoing as well as other technical contents, features, and effects of the present invention will be clearly apparent from the following detailed description with reference to the preferred embodiments of the drawings. However, it should be noted that the following embodiments are not intended to limit the present invention.

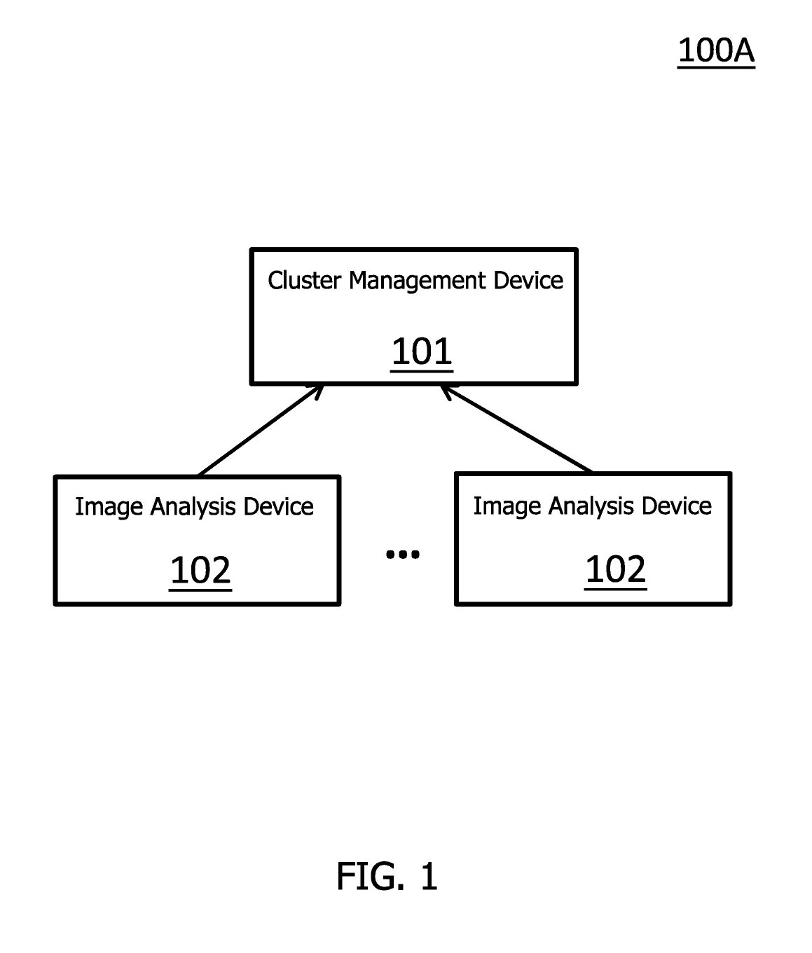

FIG. 1 illustrates a distributed image analysis system 100A according to one embodiment of the present invention, wherein the image analysis system 100A comprises: a plurality of image analysis devices 102 for analyzing video streams; and a cluster management device 101 connected to the plurality of image analysis devices 102, wherein when a first image analysis device of the plurality of image analysis devices 102 performs analyses of a video stream but is not capable of completing the analyses of the video stream by itself, the first image analysis device transfers at least one portion of the tasks of the video stream analyses to the cluster management device 101 and/or at least one second analysis device via the cluster management device 101 to perform the at least one portion of the tasks of the video stream analyses. The cluster management device 101 then returns an execution result of at least one portion of the tasks of the video stream analyses back to the image analysis device, so that the first image analysis device can integrate the execution result of at least one portion of the tasks of the video stream analyses so as to complete the analysis of the video stream. Please note that the present invention is not limited to the manner in which the image analysis device receives video streams. The image analysis device 102 can be connected to a camera device through the Internet, or the image analysis device 102 can be directly connected to a camera device locally, or the image analysis device 102 can obtain the video stream through other suitable means.

In one embodiment, the cluster management device 101 has image analysis capabilities, and the cluster management device 101 can perform the at least one portion of the tasks of the video stream analyses.

In one embodiment, the cluster management device does not have the image analysis capabilities.

In one embodiment, the resources of the image analysis device include at least one central processing unit (CPU).

In one embodiment, the resources of the image analysis device include at least one CPU and at least one graphics processing unit (GPU) or an image processing hardware accelerator.

In one embodiment, the resources of the image analysis device include at least one CPU and at least one image processing hardware accelerator.

In one embodiment, at least one portion of the tasks includes multiple tasks of the video stream analyses, wherein the cluster management device 101 transfers the multiple tasks of the video stream analyses to at least two image analysis devices for executing the multiple tasks of the video stream analyses, wherein each of at least two image analysis devices returns an result of an executed task to the cluster management device 101, respectively. The cluster management device 101 then returns the results of the executed tasks back to the image analysis device, so that the image analysis device can further integrate the results of the executed tasks for completing the analysis of the video stream.

In one embodiment, at least one portion of the tasks includes multiple tasks of the video stream analyses, wherein the cluster management device 101 transfers the multiple tasks of the video stream analyses to at least two image analysis devices for executing the multiple tasks of the video stream analyses, wherein each of at least two image analysis devices returns a result of an executed task back to the image analysis device, respectively, so that the image analysis device can further integrate the results of the executed tasks for completing the analysis of the video stream.

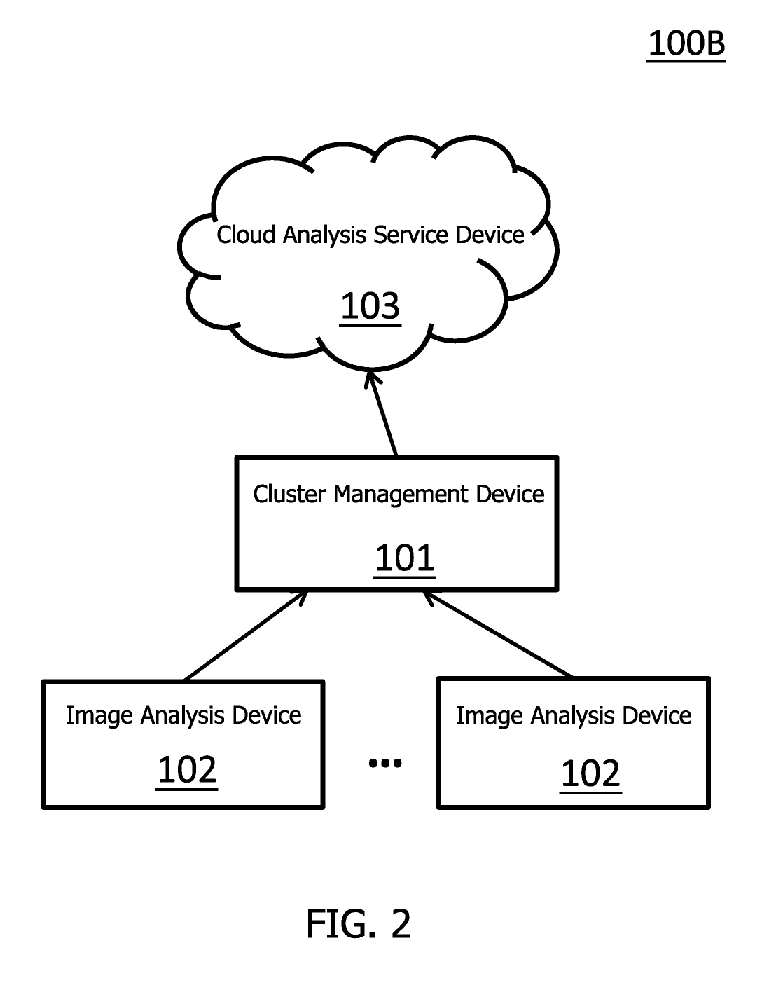

FIG. 2 illustrates a distributed image analysis system 100B according to one embodiment of the present invention, wherein the image analysis system 100B comprises: a plurality of image analysis devices 102 for analyzing video streams; and a cluster management device 101 connected to the plurality of image analysis devices 102. The cluster management device 101 is connected to a cloud analysis service device 103, wherein when a first image analysis device of the plurality of image analysis devices performs the analyses of a video stream but is not capable of completing the analyses of the video stream by itself, the first image analysis device transfers at least one portion of the tasks of the video stream analyses to the cloud analysis service device 103 and/or at least one second image analysis device to via the cluster management device 101 to perform the at least one portion of the tasks of the video stream analyses. The cluster management device 101 then returns the execution result of the at least one portion of the tasks of the video stream analyses back to the first image analysis device, and the first image analysis device further integrates the execution results of the at least one portion of the tasks of the video stream analyses for completing the analysis of the video stream.

In one embodiment, the at least one portion of the tasks of the video stream analyses includes a first task of the cloud analysis service device 103. The cluster management device 101 transfers the first task to the cloud analysis service device 103 for execution, and the cluster management device 101 returns the execution result of the first task to the image analysis device. Alternatively, the cloud analysis service device 103 returns the execution result of the first task to the first image analysis device rather than through the cluster management device 101. In one embodiment, the at least one portion of the tasks of the video stream analyses includes a first task transferred to the cloud analysis server 103 for execution and a second task is transferred to a second image analysis device for execution. The cluster management device 101 transfers the first task to the cloud analysis service device 103 for execution. The cluster management device 101 transfers the second task to the second image analysis devices for execution. The cluster management device 101 then returns the execution result of the first task executed by the cloud analysis service device 103 and the execution result of the second task executed by the second analysis service device back to the first image analysis device. In one embodiment, the cloud analysis service device 103 can return the execution result of the first task to the image analysis device directly without going through the cluster management device 101. The second image analysis device can also return the execution result of the second task back to the first image analysis device directly without going through the cluster management device 101.

In one embodiment, the processing capabilities of the first image analysis device can perform a real-time analysis of a portion of the video stream, such as face recognition of a very important person (VIP) or license plate recognition in a parking lot that requires a real-time analysis result.

In one embodiment, the processing capability of a local image analysis device can perform analyses of a video stream that does not require real-time analysis results, i.e. the analyses result of the video stream can tolerate a time delay. If the computing power of the local image analysis device is not enough, a portion of the tasks can be transferred to other image analysis devices through the cluster management device, and the result can be returned to the local image analysis device via the cluster management device or without going through the cluster management device. For example, the image analyses of a real-time video containing a huge crowd, and the facial feature extraction and analysis can be performed for searching some persons in a semi real-time manner with no need to generate real-time alerts. In this case, the local image analysis device can perform video streaming receiving tasks and face detection tasks to capture human faces. The cluster management device can then distribute information of the human faces to other image analysis devices for facial feature extraction and analysis. Lastly, the results of the facial feature extraction and analysis will be integrated by the local image analysis device. If the local image analysis device cannot provide all of the capabilities of analyzing a video stream, a portion of the tasks can be transferred to the cloud analysis service through the cluster management device, and then the execution results of said portion of the tasks can be returned to the local image analysis device via the cluster management device or returned to the local image analysis device directly without going through the cluster management device. For example, there is a real-time image that contains a complicated scene, and it is desirable to perform image analyses to detect abnormal conditions in that real-time image for generating semi real-time alerts. As big data learning and analyses require a substantial amount of computing power or resources, the local image analysis device does not have the capability of analyzing such a complicated scene. The cloud analysis service device can perform complicated computation to analyze such a complicated scene. In this case, the local image analysis device receives the video stream and finds an image that can represent the scene. The local image analysis device can then transmit the image representing the scene to the cloud analysis service device directly or via the cluster management device, and the cloud analysis service device finally returns the result back to the local image analysis device for generating an alert if an abnormal condition is found.

In one embodiment, the image analysis device can use temporarily stored video streams to perform offline image analysis or use video files to generate analysis results in a non-real time manner. The operation mechanism is the same as the aforementioned semi real-time video stream analyses, but the response time is not required and the scheduling priority is low.

In one embodiment, the image analysis device can use real-time video streams or temporarily stored video streams or video files for image analyses over a long period of time for generating statistics of the results of the image analyses to obtain a trend or forecast, wherein statistics of the results of the image analyses can be generated by the cloud service device.

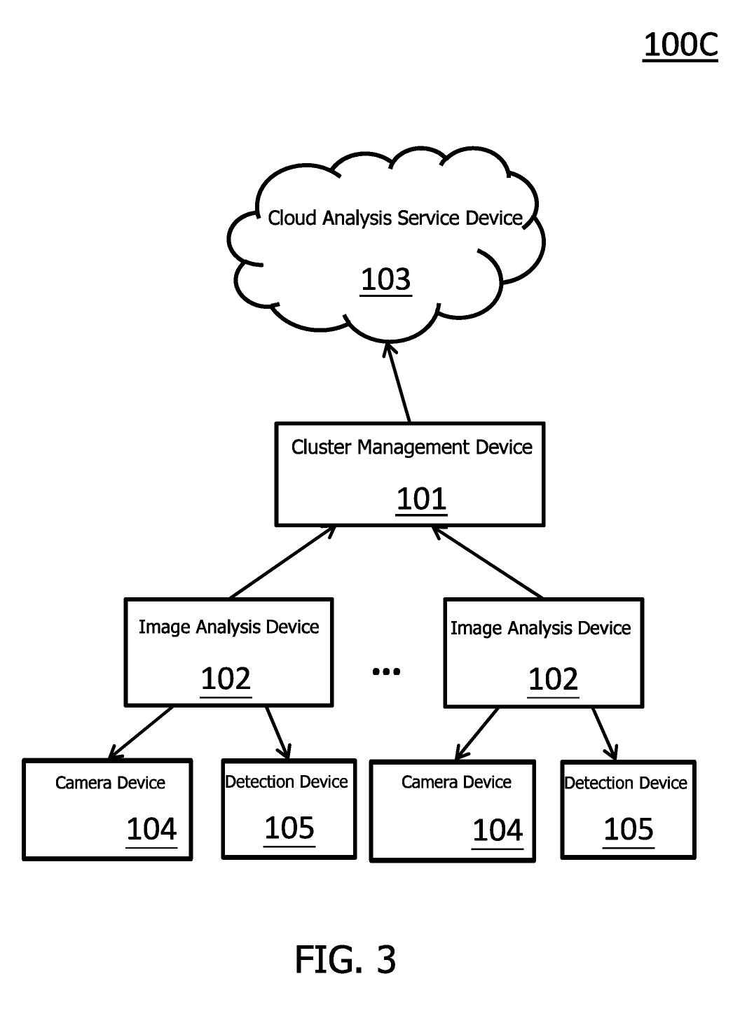

FIG. 3 illustrates a distributed image analysis system 100C according to one embodiment of the present invention, wherein the image analysis device 102 is connected to a camera device 104 for obtaining video streams captured by the camera device 104. When the image analysis device detects an event in an image representing a scene, the image analysis of the image of representing the scene is transferred to the cloud analysis service device 103 to determine the probability score that the image representing the scene contains an abnormal condition, such as a dangerous article, a blaze or a fire. The cloud analysis service device then returns the probability score back to the image analysis device for generating an alert.

In one embodiment, the image analysis device of the present invention can be connected to a detection device to sense environmental changes, such as when a door is opened, a window is broken, an alarm goes off, an unusual temperature rise, etc., wherein only when the triggering condition of the environmental changes is met, the image analysis device will be triggered to perform the image analyses of the scene so as to conserve computing power as well as to reduce false alarms. For example, the scene is in a server room, a temperature sensing device is used for detecting the temperature of the server room, and the image analysis device monitors the temperature of the server room through the temperature sensing device. If an abnormal temperature rise is detected in the server room by the temperature sensing device, the temperature sensing device will send a message to the image analysis device so that the image analysis device can perform image analysis of the scene. In one embodiment, an image representing a scene of the server room can be transferred to the cloud analysis service device to determine the probability score that there is a fire in the image representing the scene. The cloud analysis service device then returns the probability score back to the image analysis device for generating an alarm. In one embodiment, the probability score can be obtained by matching a pattern in an existing database.

In one embodiment, the image analysis device can perform a preliminary image analysis of a scene. When a triggering condition is met, such as a motion of an object is detected, a human is present, an intrusion occurs, etc., further image analysis on the scene can be performed for saving computing power as well as reducing false alarms. For example, the scene is in a bank lobby, and if the preliminary image analysis of the scene detects a new person has entered into the bank lobby, the image analysis device will be triggered to capture the person and the surrounding of the person, and the images of the person and the surrounding of the person can be transferred to the cloud analysis service device to determine the probability score that the person carries a dangerous article, such as a gun or a knife. The cloud analyses service device then returns the probability score back to the image analysis device for generating an alert.

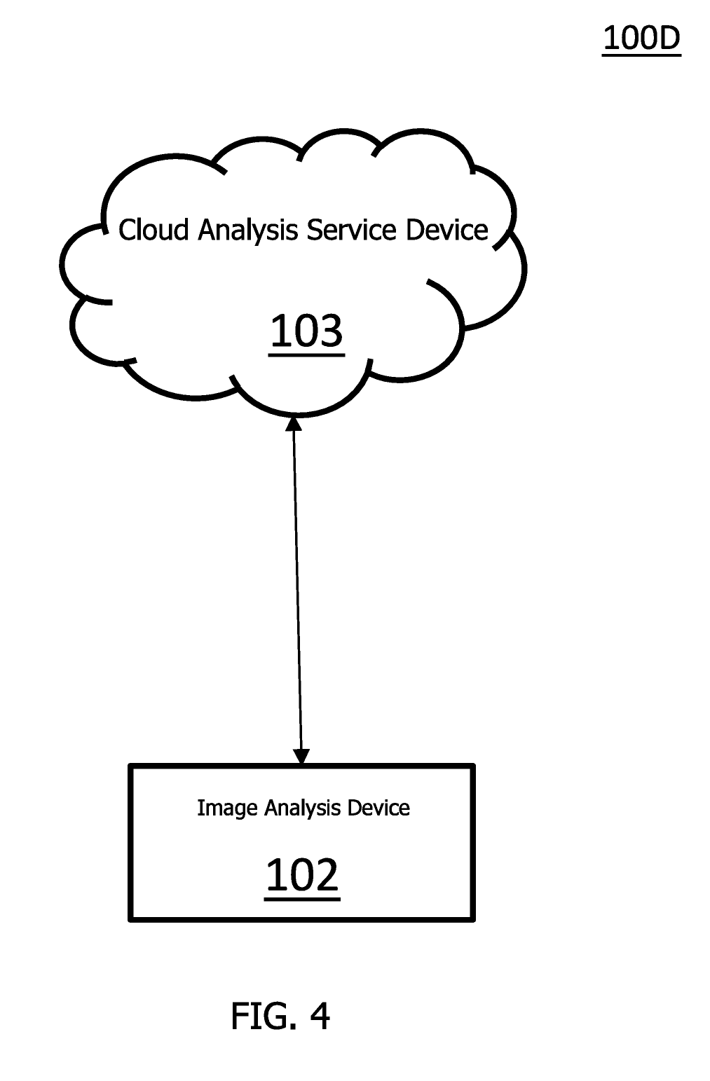

FIG. 4 illustrates the image analysis system 100D according to one embodiment of the present invention, wherein the image analysis system 100D comprises: an image analysis device 102, wherein the image analysis device 102 is connected to a cloud analysis service device 103; wherein when the image analysis device 102 performs image analyses of a video stream but is not capable of analyzing a scene, the image analysis device 102 transfers an image representing the scene to the cloud analysis service device 103 for analyzing the scene The cloud analysis service device 103 then returns the image analysis result of the scene back to the image analysis device 102 for completing the analysis of the video stream. The descriptions in paragraph [0041] and [0042] can be applied to FIG. 4 as well.

The above-mentioned descriptions represent merely the exemplary embodiment of the present invention, without any intention to limit the scope of the present invention thereto. Various equivalent changes, alternations or modifications based on the claims of present invention are all consequently viewed as being embraced by the scope of the present invention.

What is claimed is:

1. A distributed image analysis system, comprising:
a plurality of image analysis devices for analyzing video streams; and
a cluster management device connected to the plurality of image analysis devices;
wherein when a first image analysis device of the plurality of image analysis devices performs the analyses of a video stream but is not capable of completing the analyses of the video stream by itself, at least one portion of the tasks of the analyses of the video stream is transferred to the cluster management device and/or at least one second image analysis device of the plurality of image analysis devices so as to complete the analyses of the video stream.

2. The system according to claim 1, wherein the cluster management device transfers the at least one portion of the tasks of the analyses of the video stream to the at least one second image analysis device, and the cluster management device transmits an execution result of the at least one portion of the tasks of the analyses of the video stream back to the first image analysis device so as to complete the video stream analyses.

3. The system according to claim 1, wherein the cluster management device is connected to a cloud analysis service device, wherein when the at least one portion of the tasks of the analyses of the video stream includes an image analysis task, and the plurality of image analysis devices do not have the capability of performing said image analysis task, the cluster management device transfers the image analysis task to the cloud analysis service device for execution, and an execution result of the image analysis task is transmitted back to the first image analysis device from the cloud analysis service device so as to complete the video stream analyses.

4. The system according to claim 3, wherein the cloud analysis service device transmits the execution result of the image analysis task back to the first image analysis device through the cluster management device.

5. The system according to claim 3, the cloud analysis service device transmits the execution result of the image analysis task back to the first image analysis device directly.

6. The system according to claim 3, wherein when the first image analysis device detects an event in an analysis of an image, the first image analysis device transfers the image to the cloud analysis service device for determining a probability score that the image contains an abnormal condition, and the cloud analysis service device transmits the probability score back to the first image analysis device.

7. The system according to claim 6, wherein the first image analysis device detects the event by performing a preliminary analysis of the image, and the event is detected when a result of the preliminary analysis meets a triggering condition.

8. The system according to claim 6, wherein the first image analysis device receives a message from a detection device so as to detect the event.

9. The system according to claim 6, wherein the abnormal condition is detected when the image contains a dangerous article or a fire scene.

10. The system according to claim 7, wherein the triggering condition is a motion of an object.

11. The system according to claim 8, wherein the detection device is a temperature detection device.

12. A distributed image analysis system, comprising:
a plurality of image analysis devices for analyzing video streams; and
a cluster management device connected to the plurality of image analysis devices;
wherein when a first image analysis device of the plurality of image analysis devices performs the analyses of a video stream but is not capable of completing the analyses of the video stream by itself, at least one portion of the tasks of the analyses of the video stream is transferred to the cloud analysis service device and/or at least one second image analysis device of the plurality of image analysis devices via the cluster management device so as to complete the analyses of the video stream.

13. A distributed image analysis system, comprising:
an image analysis device, wherein the image analysis device is connected to a cloud analysis service device; and
wherein when the image analysis device performs the analyses of a video stream but is not capable of completing the analyses of the video stream by itself, at least one portion of the tasks of the analyses of the video stream is transferred to the cloud analysis service device and the cloud analysis service device transmits a result of the at least one portion of the tasks of the analyses of the video stream back to the image analysis device so as to complete the analyses of the video stream.

14. The system according to claim 13, wherein when the image analysis device detects an event in an image, the image analysis device transfers the image to the cloud analysis service device to determine a probability score that the image contains an abnormal condition, and the cloud analysis service device transmits the probability score back to the image analysis device.

15. The system according to claim 14, wherein the image analysis device detects the event by a preliminary analysis of the image, and the event is detected when the preliminary analysis meets a triggering condition.

16. The system according to claim 14, wherein the image analysis device receives a message from a detection device so as to detect the event.

17. The system according to claim 14, wherein the abnormal condition is detected when the image contains a dangerous article or a fire scene.

18. The system according to claim 15, wherein the triggering condition is a motion of an object.

19. The system according to claim 16, wherein the detection device is a temperature detection device.
